(19) United States
(12) Patent Application Publication
(10) Pub. No.: US 2026/0154833 A1
(43) Pub. Date: Jun. 4, 2026

(54) DEPTH MAP ESTIMATION METHOD AND SYSTEM USING UNIVERSAL FRAMEWORK

(71) Applicant: GWANGJU INSTITUTE OF SCIENCE AND TECHNOLOGY, Gwangju (KR)

(72) Inventors: Hae Gon JEON, Gwangju (KR); Jin Hwi PARK, Gwangju (KR)

(73) Assignee: GWANGJU INSTITUTE OF SCIENCE AND TECHNOLOGY, Gwangju (KR)

(21) Appl. No.: 19/366,705

(22) Filed: Oct. 23, 2025

(30) Foreign Application Priority Data
Dec. 3, 2024 (KR) 10-2024-0177675

(51) Int. Cl. G06T 7/50; G06T 5/20

(52) U.S. Cl. CPC G06T 7/50; G06T 5/20

(57) ABSTRACT

Disclosed herein is a depth map estimation method including acquiring multiple feature maps corresponding to a given image using a pre-trained depth model, generating a first feature map in a Euclidean space by fusing the multiple feature maps, and generate a second feature map by mapping the first feature map to a hyperbolic space, estimating a bidirectional kernel filter using the first feature map and the second feature map, and generating an initial depth map using the bidirectional kernel filter and an effective depth map, and calculating a hyperbolic affinity map based on a curvature in the hyperbolic space, and correcting the initial depth map based on the hyperbolic affinity map.

### CROSS REFERENCE TO RELATED APPLICATION

The present application claims priority to Korean Patent Application No. 10-2024-0177675, filed Dec. 3, 2024, the entire contents of which are hereby incorporated by reference in its entirety.

### BACKGROUND

### Field of the Invention

The disclosed embodiments relate to a depth map estimation method and system using a universal framework.

### Description of the Related Art

Depth map estimation technology is being actively researched to accurately estimate dense depth maps in various computer vision fields such as scene understanding, 3D reconstruction, and autonomous driving. In particular, in order to estimate the dense depth map, much effort is required to process occlusion of a scene observed in an image or differences in illumination between viewpoints. In addition, the depth map may be acquired through active depth sensors such as a light detection and ranging (LiDAR) or a time-of-flight (ToF) camera.

In this regard, research has been conducted on depth completion, which estimates a depth map from a pair of image and low-resolution depth map captured by the active depth sensor. The depth completion predicts a dense depth map from a sparse depth map by using an affinity map based on an image.

To this end, a method of estimating a depth map based on a learning model has been studied recently. However, the method requires a method to generalize the accuracy of depth map estimation based on a new environment or a universal sensor type. In particular, the learning model may acquire a generalized model by training a large model based on large-scale and diverse datasets. To this end, a lot of resources are required in a process of acquiring an accurate and dense depth map as correct data (e.g., ground-truth).

### SUMMARY

The disclosed embodiments are intended to provide a depth map estimation method and system using a universal framework capable of generating a depth map with stable quality from images acquired through various types of monocular cameras or depth sensors.

In addition, the disclosed embodiments are intended to provide a depth map estimation method and system using a universal framework capable of generating a more accurate and dense depth map.

There is provided a depth map estimation method according to an embodiment. The depth map estimation method may include: acquiring multiple feature maps corresponding to a given image using a pre-trained depth model; generating a first feature map corresponding to the image in a Euclidean space by fusing the multiple feature maps, and generating a second feature map by mapping the first feature map to a hyperbolic space; estimating a bidirectional kernel filter using the first feature map and the second feature map, and generating an initial depth map using the bidirectional kernel filter and an effective depth map corresponding to the image; and calculating a hyperbolic affinity map based on a curvature in the hyperbolic space estimated based on the first feature map, and generating a depth map corresponding to the image by correcting the initial depth map based on the hyperbolic affinity map.

There is provided a depth map estimation system according to an embodiment. The depth map estimation system may include: a storage unit in which a pre-trained depth model is prepared; and a control unit acquiring multiple feature maps corresponding to a given image using the depth model, and generating a depth map corresponding to the image using the multiple feature maps, in which the control unit may generate a first feature map corresponding to the image in a Euclidean space by fusing the multiple feature maps, generate a second feature map by mapping the first feature map to a hyperbolic space, estimate a bidirectional kernel filter using the first feature map and the second feature map, generate an initial depth map using the bidirectional kernel filter and an effective depth map corresponding to the image, calculate a hyperbolic affinity map based on a curvature in the hyperbolic space estimated based on the first feature map, and generate a depth map corresponding to the image by correcting the initial depth map based on the hyperbolic affinity map.

There is provided a program stored on a computer-readable recording medium according to an embodiment, which is executed by one or more processes in an electronic device. The program may include instructions to perform the following steps: acquiring multiple feature maps corresponding to a given image using a pre-trained depth model; generating a first feature map corresponding to the image in a Euclidean space by fusing the multiple feature maps, and generating a second feature map by mapping the first feature map to a hyperbolic space; estimating a bidirectional kernel filter using the first feature map and the second feature map, and generating an initial depth map using the bidirectional kernel filter and an effective depth map corresponding to the image; and calculating a hyperbolic affinity map based on a curvature in the hyperbolic space estimated based on the first feature map, and generating a depth map corresponding to the image by correcting the initial depth map based on the hyperbolic affinity map.

According to the depth map estimation method and system using a universal framework according to various embodiments of the present invention, by generating the feature maps in the Euclidean space and the feature maps in the hyperbolic space using the multiple feature maps acquired from the images based on the multiple scale factors, and generating the depth maps by considering each feature map, it is possible to generate the depth maps with stable quality from the images acquired through various types of monocular cameras or depth sensors.

According to the depth map estimation method and system using a universal framework according to various embodiments of the present invention, by estimating the initial depth map and correcting the initial depth map using the feature map in the Euclidean space and the pixel-wise affinity map based on the curvature in the hyperbolic space, it is possible to generate the more accurate and dense depth map.

### BRIEF DESCRIPTION OF THE DRAWINGS

FIGS. 1 and 2 illustrate an embodiment of a framework of a depth map estimation system according to the present invention.

FIG. 3 illustrates a depth map estimation system according to the present invention.

FIG. 4 illustrates a depth map estimation method according to the present invention.

FIG. 5 illustrates an embodiment of generating multiple feature maps.

FIG. 6 illustrates an embodiment of generating a first feature map.

FIG. 7 illustrates an embodiment of generating a second feature map.

FIG. 8 illustrates an embodiment of generating a bidirectional kernel filter.

FIG. 9 illustrates an embodiment of a method of generating a bidirectional kernel filter.

FIG. 10 illustrates an embodiment of a method of generating an initial depth map.

FIG. 11 illustrates an embodiment of a method of correcting an initial depth map.

FIG. 12 is a block diagram illustrating an embodiment of a computing system in which the present invention can be implemented.

FIGS. 13 and 14 are block diagrams illustrating an embodiment of a computing device according to the present invention.

### DETAILED DESCRIPTION

Hereafter, embodiments described in the present specification will be described in detail with reference to the accompanying drawings and the same or similar components are given the same reference numerals regardless of reference numerals and are not repeatedly described. In addition, terms “module” and “unit” for components used in the following description are used only to easily make the present invention. Therefore, these terms do not have meanings or roles that distinguish from each other in themselves. Further, in describing the embodiments disclosed in the present specification, when it is determined that a detailed description for the known art related to the present invention may obscure the gist of the embodiments described in the present specification, the detailed description will be omitted. Further, it should be understood that the accompanying drawings are provided only in order to allow the embodiments described in the present specification to be easily understood, and the spirit of the present invention is not limited by the accompanying drawings, but includes all the modifications, equivalents, and substitutions included in the spirit and the scope of the present invention.

Terms including ordinal numbers such as “first,” “second,” etc., may be used to describe various components, but the components are not to be construed as being limited to the terms. The terms are only used to differentiate one component from other components.

It is to be understood that when a component is referred to as being “connected to” or “coupled to” another component, it may be connected directly to or coupled directly to another element or be connected to or coupled to another element, having other components intervening therebetween. On the other hand, it should be understood that when one component is referred to as being “connected directly to” or “coupled directly to” another component, it may be connected to or coupled to another component without other components interposed therebetween.

Singular expressions are intended to include plural expressions unless the context clearly indicates otherwise.

It will be further understood that terms “include” or “have” used in the present specification specify the presence of features, numerals, steps, operations, components, parts mentioned in the present specification, or combinations thereof, but do not preclude the presence or addition of one or more other features, numerals, steps, operations, components, parts, or combinations thereof.

### Overall Content of the Present Invention

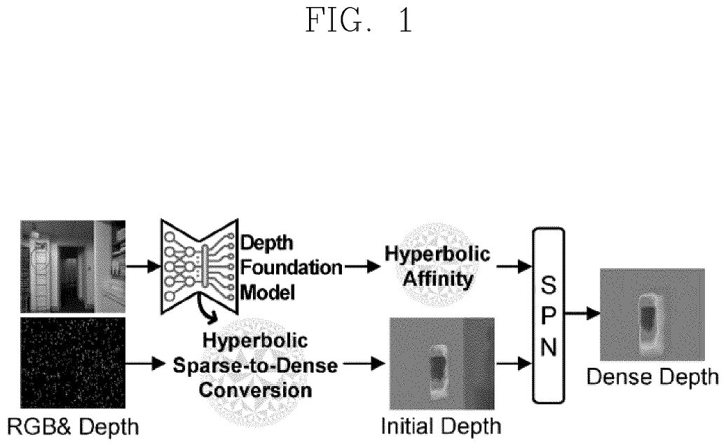

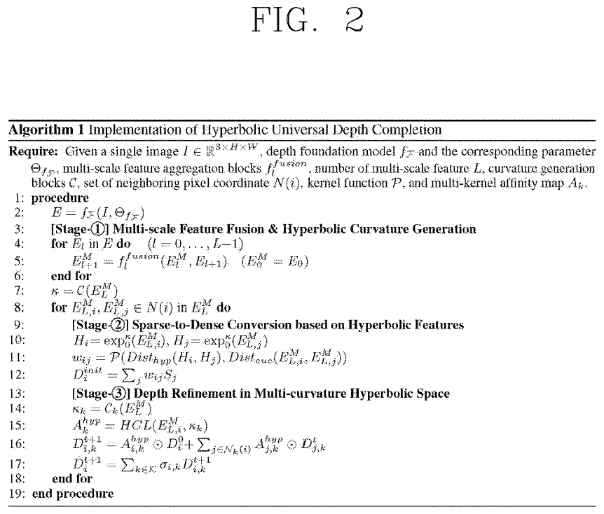

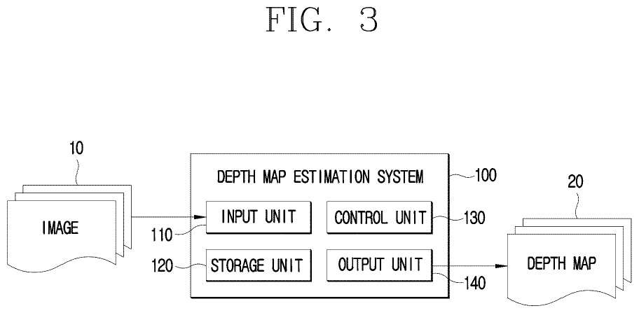

FIGS. 1 and 2 illustrate an embodiment of a framework of a depth map estimation system according to the present invention. FIG. 3 illustrates a depth map estimation system according to the present invention.

Referring to FIGS. 1 and 2, a depth map estimation system 100 according to the present invention may acquire multiple feature maps from an image using a depth model, generate a first feature map in a Euclidean space and a second feature map in a hyperbolic space based on the multiple feature maps, generate an initial depth map using a bidirectional kernel filter generated based on the first feature map and the second feature map, and an effective depth map corresponding to the image, and generate a depth map corresponding to the image by correcting the initial depth map.

Here, the image is captured by a predetermined camera, and in one embodiment, the image may be captured using a monocular camera.

The depth model may be trained to output multiple feature maps based on different multiple scale factors and effective depth maps according to the multiple feature maps when a given image is input.

To this end, the depth model may be trained by using a training image and a ground-truth depth map. That is, when the training image is input to the depth model and a training effective depth map is output, the depth model may be a model that calculates a loss for the depth model by comparing the training effective depth map with the ground-truth depth map and trains model parameters of the depth model based on the calculated loss.

In an embodiment, the depth model may be a model that performs basic training based on large-scale training data, and performs bias tuning based on the loss according to the training image and the ground-truth depth map.

Meanwhile, according to an embodiment, the effective depth map may be replaced with a depth map measured by a sensor provided with a predetermined camera while capturing an image through the predetermined camera. In this case, the sensor may be a light detection and ranging (LiDAR) sensor, and may be provided to transmit a laser beam to an area captured by the camera, detect a laser beam reflected by a predetermined object, and measure a time interval between a transmission time and a detection time of the laser beam. Accordingly, the effective depth map may be generated to represent a depth of an object captured in an image based on the time interval measured by the sensor.

Here, the large-scale training data may include an image for a wide range of fields, and therefore, the basic training may be understood as training a weight of the depth model to extract multiple feature maps according to multiple scale factors from the large-scale training data. In this case, the basic training may be performed for each of the multiple scale factors provided in the depth model.

In this case, the multiple scale factors are multiple hidden layers provided in the depth model, and may be provided to extract a feature map from an image input to the depth model and reduce a size (or dimension) of the previously extracted feature map to a predetermined ratio to generate multiple feature maps having different sizes. Each of the multiple hidden layers may be composed of a convolutional layer and a pooling layer according to an embodiment, and may be implemented to reduce the images (or feature maps) input to each hidden layer to a predetermined size (e.g., ½).

In addition, when a feature map corresponding to a given image is extracted based on the weight of the depth model, the bias tuning may be understood as training a predetermined bias added to the feature map so that the effective depth map is estimated from the extracted feature map.

Therefore, when the training image is input to the depth model on which the basic training has been performed and the training effective depth map is output, the depth model may perform the bias tuning by comparing the training effective depth map with the ground-truth depth map to calculate the loss for the depth model and training the bias parameters of the depth model based on the calculated loss. In this case, the bias tuning may be performed on at least one of the multiple scale factors provided in the depth model.

In an embodiment, the bias tuning may be performed on the depth model according to the following Equation 1.

$${L}_{scale - invariant} ( {D}_{relaive} , {D}_{gt} ) = \frac{1}{\vert V \vert} {\sum }_{v ∈ V} ( {δ}_{v}^{2} ) - \frac{λ}{{\vert V \vert}^{2}} {( {\sum }_{v ∈ V} {δ}_{v} )}^{2} \qquad [ Equation 1 ]$$

$${δ}_{v} = log {D}_{relative} ( v ) - log {D}_{gt} ( v )$$

Here, L_{scale-invariant} may represent the loss for the depth model, Dᵣₑₗₐₜᵢᵥₑ may represent the training effective depth map, and D_{gt} may represent the ground-truth depth map. In addition, λ may be a parameter for a loss, that is set to a predetermined value (e.g., 0.85).

The first feature map may be a synthesis of one feature map and another feature map among the multiple feature maps extracted based on the multiple scale factors provided in the depth model. In this case, the depth map estimation system 100 may upsample a relatively coarse feature map among the multiple feature maps and synthesize other feature maps that are finer than the corresponding feature map and an upsampled coarse feature map.

To this end, the depth map estimation system 100 may perform upsampling by performing a transposed convolution on the coarse feature map. In this case, the upsampled coarse feature map and the other fine feature map may be synthesized through skip-concatenation. Accordingly, the depth map estimation system 100 may generate the first feature map by repeating the synthesis process described above for the multiple feature maps extracted from the depth model.

In addition, in an embodiment, the depth map estimation system 100 includes an encoder and a decoder that are provided in the depth model, and when downsampling is performed on an image (or feature map) through a convolutional layer in the encoder, and upsampling is performed on the feature map through a transposed convolutional layer in the decoder, the depth map estimation system 100 may generate the first feature map by repeating a process of skip-concatenating the feature map extracted by the encoder to the upsampled feature maps in the decoder.

The process of synthesizing the multiple feature maps may be expressed as the following Equation 2.

$${E}_{l + 1}^{M} = {f}_{l}^{fusion} ( {E}_{l}^{M} , {E}_{l + 1} ) \qquad [ Equation 2 ]$$

Here,

$${E}_{l + 1}^{M}$$

may represent the feature map (e.g., the first feature map) in which the coarse feature map and the fine feature map are synthesized,

$${f}_{l}^{fusion}$$

may represent a multi-scale feature map synthesis block composed of the skip-concatenation and the transposed convolutional layer,

$${E}_{l}^{M}$$

may represent the upsampled coarse feature map, and Eₗ₊₁ may represent the fine feature map.

The second feature map may be obtained by mapping each of a plurality of pixel values belonging to the first feature map to a hyperbolic space using a curvature generated based on the first feature map.

To this end, the depth map estimation system 100 may generate the curvature in the hyperbolic space corresponding to the first feature map using a pre-prepared curvature generation model. Here, the curvature generation model may be composed of a convolutional layer based on a hyperparameter, a multilayer perceptron (MLP) layer, and a global mean pooling layer.

That is, the curvature generation model may be a model that trains (or optimizes) hyperparameters by repeating mapping between the first feature map and the second feature map while estimating the depth map from the image. According to an embodiment, the curvature generation model may be trained using the training image and the ground-truth depth map.

For example, the curvature generation model may be implemented so that, when the first training feature map generated from the training image based on the depth model is input, a second training feature map corresponding to the first training feature map is output. Accordingly, the curvature generation model may calculate the loss by comparing the depth map for training generated based on the first training feature map and the second training feature map with the ground-truth depth map, and may be trained based on the calculated loss.

Meanwhile, the curvature generation model may be expressed as in the following Equation 3.

$$k = C ( {E}_{L}^{M} ) \qquad [ Equation 3 ]$$

Here, k may represent the curvature in the hyperbolic space corresponding to the first feature map, C may represent the curvature generation model, and

$${E}_{L}^{M}$$

may represent the first feature map.

Accordingly, the depth map estimation system 100 may generate the second feature map by calculating the value in the hyperbolic space corresponding to each pixel of the first feature map using the curvature generated based on the first feature map.

In this regard, the Euclidean space corresponding to the first feature map and the hyperbolic space corresponding to the second feature map may be mapped based on an exponential function and a logarithmic function, and the mapping relationship may be expressed as in the following Equation 4.

$${exp}_{0}^{k} ( x ) = tanh ( \frac{\sqrt{k} ‖ x ‖}{2} ) \frac{x}{\sqrt{k} ‖ x ‖} \qquad [ Equation 4 ]$$

$${log}_{0}^{k} ( u ) = {tanh}^{- 1} ( \sqrt{k} ‖ u ‖ ) \frac{u}{\sqrt{k} ‖ u ‖}$$

Here, x may represent any value in the Euclidean space, and u may represent any value in the hyperbolic space.

Therefore, the depth map estimation system 100 may calculate the second feature map corresponding to the first feature map according to the following Equation 5 based on the mapping relationship as in Equation 4.

$${H}_{i} = {exp}_{0}^{k} ( {E}_{L , i}^{M} ) \qquad [ Equation 5 ]$$

Here, Hᵢ may represent a value corresponding to i pixel in the second feature map, and

$${E}_{L , i}^{M}$$

may represent a value corresponding to i pixel in the first feature map.

The bidirectional kernel filter may mean a coefficient for a depth map generated by considering both Euclidean geometry and hyperbolic geometry according to the first feature map and the second feature map. To this end, the bidirectional kernel filter may be calculated based on a Euclidean distance between a specific pixel and a neighboring pixel adjacent to the corresponding pixel, in the first feature map, and a hyperbolic distance between a point corresponding to the specific pixel in the first feature map and a point corresponding to the neighboring pixel in the first feature map, in the second feature map.

In this case, the bidirectional kernel filter may be calculated for each of all the pixels adjacent to the specific pixel in the first feature map.

In an embodiment, the bidirectional kernel filter may be calculated according to the following Equation 6.

$${w}_{i , j} = {f}_{r} ( {x}_{j} , {x}_{i} ) {g}_{s} ( {x}_{j} - {x}_{i} ) \qquad [ Equation 6 ]$$

Here, w_{i,j} may represent a bidirectional kernel filter for j pixel, which is one of the neighboring pixels adjacent to the i pixel which is the specific pixel, fr may represent the hyperbolic distance, gs may represent the Euclidean distance, xᵢ may represent the specific pixel (and the point corresponding to the specific pixel of the first feature map, in the second feature map) in the first feature map as the i pixel, and xⱼ may represent a jth neighboring pixel among a plurality of neighboring pixels adjacent to the specific pixel.

In this regard, the bidirectional kernel filter may be generated using the bidirectional kernel filter model composed of the multilayer perceptron layer. In this case, the bidirectional kernel filter model may be trained to output the bidirectional kernel filters corresponding to the first feature map and the second feature map when the first feature map and the second feature map are input.

According to an embodiment, the bidirectional kernel filter model may be implemented to calculate the Euclidean distance between each of the plurality of pixels belonging to the first feature map and the adjacent pixels, calculate the hyperbolic distance between a point corresponding to each of the plurality of pixels of the first feature map and points corresponding to the adjacent pixels in the first feature map, in the second feature map, and generate the bidirectional kernel filter corresponding to each pixel using the Euclidean distance and the hyperbolic distance calculated for each pixel.

Alternatively, the bidirectional kernel model may be trained to generate the bidirectional kernel filters corresponding to any first and second feature maps by repeatedly calculating the bidirectional kernel filter according to the first feature map and the second feature map while estimating the depth map from the image.

For example, the bidirectional kernel filter model may be trained using the training image and the ground-truth depth map. That is, the bidirectional kernel filter generation model may be implemented to output the training bidirectional kernel filters corresponding to the first training feature map and the second training feature map when the first training feature map and the second training feature map generated from the training image based on the depth model and the curvature generation model are input.

In this case, the bidirectional kernel filter generation model may calculate the loss by comparing the training depth map generated based on the training effective depth map acquired based on the training bidirectional kernel filter and the depth model with the ground-truth depth map, and may be trained based on the calculated loss.

According to the embodiment, the bidirectional kernel filter may be expressed as in the following Equation 7.

$${w}_{ij} = P ( {Dist}_{hyp} ( {H}_{i} , {H}_{j} ) , {Dist}_{euc} ( {E}_{L , i}^{M} , {E}_{L , j}^{M} ) ) \qquad [ Equation 7 ]$$

Here, P may represent the bidirectional kernel filter model composed of the multilayer perceptron layer, Dist_{hyp} may represent the hyperbolic distance between the point corresponding to the specific pixel in the second feature map and the point corresponding to the neighboring pixel, and Dist_{euc} may represent the Euclidean distance between the specific pixel and the neighboring pixel in the first feature map.

The initial depth map is a depth map generated using the first feature map and the second feature map generated from the image, and may be generated using the bidirectional kernel filter corresponding to each of the plurality of neighboring pixels for the specific pixel in the first feature map and the depth value of the pixel corresponding to each of the plurality of neighboring pixels in the effective depth map.

That is, the depth map estimation system 100 may calculate the initial depth value corresponding to the specific pixel of the image using the bidirectional kernel filter corresponding to each of the plurality of neighboring pixels adjacent to the corresponding pixel and the depth value in the effective depth map, and may generate the initial depth map corresponding to the image by calculating depth values for all pixels of the image in the manner described above.

In an embodiment, the depth map estimation system 100 may generate the initial depth map using the following Equation 8.

$${D}_{i}^{init} = {\sum }_{j} {w}_{ij} {S}_{j} \qquad [ Equation 8 ]$$

Here,

$${D}_{i}^{init}$$

may represent the initial depth map, and Sⱼ may represent the effective depth map. Therefore, for the specific pixel of the initial depth map, the depth map estimation system 100 may generate the initial depth map using the corresponding pixel, the bidirectional kernel filter according to the neighboring pixels adjacent to the corresponding pixel, and the neighboring pixels adjacent to the corresponding pixel in the effective depth map.

The depth map is obtained by correcting the initial depth map, and may be corrected from the initial depth map by considering the hyperbolic affinity map based on the curvature in the hyperbolic space.

Here, the hyperbolic affinity map may be calculated using the curvature according to the first feature map and the plurality of pixels of the first feature map based on the pre-prepared hyperbolic convolutional layer.

In an embodiment, the hyperbolic affinity map may be calculated according to the following Equation 9.

$${A}_{k}^{hyp} = HCL ( {E}_{L , i}^{M} , {k}_{k} ) \qquad [ Equation 9 ]$$

Here,

$${A}_{k}^{hyp}$$

may represent the hyperbolic affinity map, and kₖ may represent the curvature according to the first feature map. In this case, HCL may be calculated according to the following Equation 10.

$$HCL ( h , k ) = W {⊗}_{k} {T}_{( i , j ) ∈ Ω}^{β} ( h ) {⊗}_{k} b \qquad [ Equation 10 ]$$

Here, W may represents a pre-prepared convolutional weight matrix, and b may represent a predefined bias. In this case, the convolutional weight matrix may be configured with a kernel having a predetermined size to be used in calculating the hyperbolic affinity map.

In addition, ⊗ₖ may represent a formula calculated according to the following Equation 11,

$${T}_{( i , j ) ∈ Ω}^{β}$$

may represent a formula calculated according to the following Equation 12.

$$\begin{matrix}u {⊗}_{k} v = \frac{( 1 + 2 k ( u , v ) + k ‖ v {‖}^{2} ) u + ( 1 - k {‖ u ‖}^{2} ) v}{1 + 2 k ( u , v ) + {k}^{2} {‖ u ‖}^{2} {‖ v ‖}^{2}} \\ M {⊗}_{k} u = ( \frac{1}{\sqrt{k}} ) tanh ( \frac{‖ Mu ‖}{‖ u ‖} {tanh}^{- 1} ( \sqrt{k} ‖ u ‖ ) ) \frac{Mu}{‖ Mu ‖}\end{matrix} \qquad [ Equation 11 ]$$

Here, u and v may represent values corresponding to any points in the hyperbolic space, and M may represent a predetermined matrix. In this way, the depth map estimation system 100 may map any function in the Euclidean space to a function in the hyperbolic space, and may also derive a multiplication of a Mobius matrix-vector between the matrix and the vector.

$$\begin{matrix}{T}^{β} ( {x}_{1} , {x}_{2} , … , {x}_{N} ) = M ( {( {β}_{n} {β}_{{n}_{1}}^{- 1} {v}_{1}^{T} , … , {β}_{n} {β}_{{n}_{N}}^{- 1} {v}_{N}^{T} )}^{T} ) \\ M ( \cdot ) = {exp}_{0}^{k} ( \cdot ) \\ {v}_{i} = {M}^{- 1} ( {x}_{i} ) \\ {β}_{n} = B ( \frac{n}{2} , \frac{1}{n} )\end{matrix} \qquad [ Equation 12 ]$$

Here, B may represent a beta distribution.

Meanwhile, the correction of the initial depth map may be performed by applying the hyperbolic affinity map to the plurality of pixels corresponding to the corresponding kernel and each of the plurality of neighboring pixels adjacent to each of the plurality of pixels using the kernel having the predetermined size based on the specific pixel in the initial depth map, and synthesizing the plurality of pixels to which the hyperbolic affinity map is applied and the plurality of neighboring pixels.

The correction of the initial depth map may be performed according to the following Equation 13.

$$\begin{matrix}{\hat{D}}_{i}^{t + 1} = {\sum }_{k ∈ K} {σ}_{i , k} {D}_{i , k}^{t + 1} \\ {D}_{i , k}^{t + 1} = {A}_{i , k} ⊙ {D}_{i}^{0} + {\sum }_{j ∈ {N}_{k} ( i )} {A}_{j , k} ⊙ {D}_{j , k}^{t}\end{matrix} \qquad [ Equation 13 ]$$

Here,

$${\hat{D}}_{i}^{t + 1}$$

may represent a specific pixel (i) in the corrected depth map,

$${D}_{i}^{0}$$

may represent the specific pixel in the initial depth map,

$${D}_{j , k}^{t}$$

may represent a neighboring pixel (j) in the depth map corrected t times, and σ_{i,k} may represent a reliability value corresponding to a specific pixel among the reliability maps for the depth model or the feature map estimated from the depth model.

In this case, the reliability map may be calculated based on the weight trained in the depth model, or may be calculated to represent the reliability of the feature map based on the effective depth map.

Furthermore, the correction of the initial depth map may be repeatedly performed based on the initial depth map and the previously corrected depth map. In this case, the correction of the initial depth map may be performed by applying the hyperbolic affinity map to the plurality of pixels corresponding to the corresponding kernel in the initial depth map and each of the plurality of adjacent neighboring pixels in the previously corrected depth map for each of the plurality of pixels, using the kernel having the predetermined size based on the specific pixel in the initial depth map, and synthesizing the plurality of pixels in the initial depth map to which the hyperbolic affinity map is applied and the plurality of neighboring pixels in the previously corrected depth map.

To this end, referring to FIG. 3, the depth map estimation system 100 according to the present invention may include an input unit 110, a storage unit 120, a control unit 130, and an output unit 140.

The input unit 110 may receive information necessary for the operation of the depth map estimation system 100 according to the present invention. To this end, the input unit 110 may be connected to a separate input device, a server, an external storage device, etc., via a wireless or wired network.

Therefore, the input unit 110 may receive a given image from a separate input device, a server, an external storage device, etc. According to the embodiment, the input unit 110 may receive the effective depth map corresponding to the corresponding image together with the given image.

In addition, the storage unit 120 may store instructions and information necessary for the operation of the depth map estimation system 100 according to the present invention. For example, the storage unit 120 may store at least one of the given image or the effective depth map input through the input unit 110.

In addition, the storage unit 120 may store the initial depth map and the depth map (e.g., the corrected depth map) generated from the image by the control unit 130, and a plurality of models (e.g., the depth model, the curvature generation model, the bidirectional kernel filter model, the hyperbolic convolutional layer, etc.) used while generating the depth map from the image.

The control unit 130 may control the overall operation of the depth map estimation system 100 according to the present invention. That is, the control unit 130 may acquire the multiple feature maps from the image using the depth model, generate the first feature map in the Euclidean space and the second feature map in the hyperbolic space based on the multiple feature maps, generate the initial depth map by using the bidirectional kernel filter generated based on the first feature map and the second feature map, and the effective depth map corresponding to the image, and generate the depth map corresponding to the image by correcting the initial depth map.

Specifically, the control unit 130 may acquire multiple feature maps corresponding to the given image using a pre-trained depth model. To this end, the control unit 130 may input the image to the depth model in which different multiple scale factors are provided to acquire multiple feature maps according to multiple scale factors and the effective depth map according to the multiple feature maps.

Accordingly, the control unit 130 may fuse the multiple feature maps to generate the first feature map corresponding to the image in the Euclidean space, and map the first feature map to the hyperbolic space to generate the second feature map.

In this case, the control unit 130 may upsample any one of the multiple feature maps extracted based on the multiple scale factors provided in the depth model, and synthesize another feature map that is finer than the any one feature map and any one feature map previously upsampled to generate the first feature map.

In addition, the control unit 130 may generate the curvature in the hyperbolic space corresponding to the first feature map using the pre-prepared curvature generation model, and map each of the plurality of pixel values belonging to the first feature map to the hyperbolic space based on the generated curvature to generate the second feature map.

In this way, the control unit 130 may estimate the bidirectional kernel filter using the first feature map and the second feature map, and generate the initial depth map using the bidirectional kernel filter and the effective depth map corresponding to the image.

To this end, the control unit 130 may calculate the Euclidean distance between the specific pixel and the neighboring pixel adjacent to the corresponding pixel in the first feature map, calculate the hyperbolic distance between the point corresponding to the specific pixel in the first feature map and the point corresponding to the neighboring pixel in the first feature map, in the second feature map, and generate the bidirectional kernel filter based on the previously calculated Euclidean distance and the hyperbolic distance.

Furthermore, the control unit 130 may generate the initial depth map using the bidirectional kernel filter corresponding to each of the plurality of neighboring pixels for the specific pixel in the first feature map, and the depth value of the pixel corresponding to each of the plurality of neighboring pixels in the effective depth map.

Meanwhile, the control unit 130 may calculate the hyperbolic affinity map based on the curvature in the hyperbolic space estimated based on the first feature map, and generate the depth map corresponding to the image by correcting the initial depth map based on the hyperbolic affinity map.

That is, the control unit 130 may generate the hyperbolic affinity map corresponding to the curvature according to the first feature map and the plurality of pixels of the first feature map using the pre-prepared hyperbolic convolutional layer.

Accordingly, the control unit 130 may generate the corrected depth map by applying the hyperbolic affinity map to the plurality of pixels corresponding to the corresponding kernel and each of the plurality of neighboring pixels adjacent to each of the plurality of pixels using the kernel having the predetermined size based on the specific pixel in the initial depth map, and synthesizing the plurality of pixels to which the hyperbolic affinity map is applied and the plurality of neighboring pixels.

In addition, the control unit 130 may again correct the depth map using the initial depth map and the previously corrected depth map. To this end, the control unit 130 map may generate the corrected depth map again by applying the hyperbolic affinity map to the plurality of pixels corresponding to the corresponding kernel in the initial depth map and each of the plurality of adjacent neighboring pixels in the previously corrected depth map for each of the plurality of pixels, using the kernel having the predetermined size based on the specific pixel in the initial depth map, and synthesizing the plurality of pixels in the initial depth map to which the hyperbolic affinity map is applied and the plurality of neighboring pixels in the previously corrected depth map.

The output unit 140 may output the information generated by the operation of the depth map estimation system 100 according to the present invention. To this end, the output unit 140 may be connected to a separate visual output device, a server, an external storage device, etc., via a wireless or wired network.

Accordingly, the output unit 140 may output at least one of the image or the effective depth map so that the user may visually confirm at least one of the image or the effective depth map through the separate output device, the server, the external storage device, etc., and may also output the initial depth map and the depth map (e.g., the corrected depth map) generated from the image. In addition, the output unit 140 may also output various types of information generated while generating the depth map from the image.

Meanwhile, according to the embodiment, the output unit 140 may transmit the image, the effective depth map, the initial depth map, the depth map (e.g., the corrected depth map), and various types of information generated while generating the depth map from the image to another device.

Based on the configuration of the depth map estimation system 100 described above, the depth map estimation method will be described in more detail below.

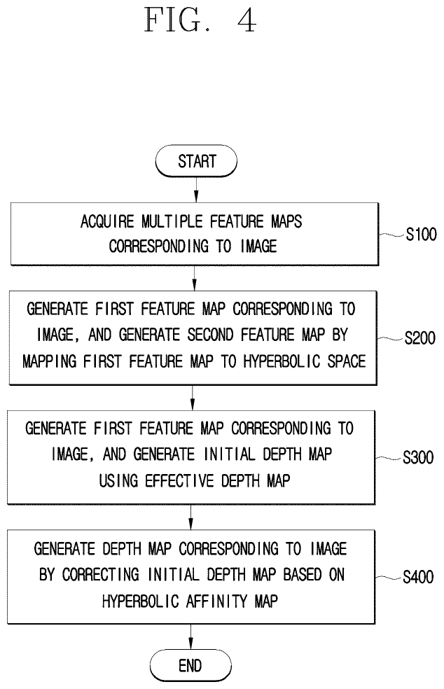

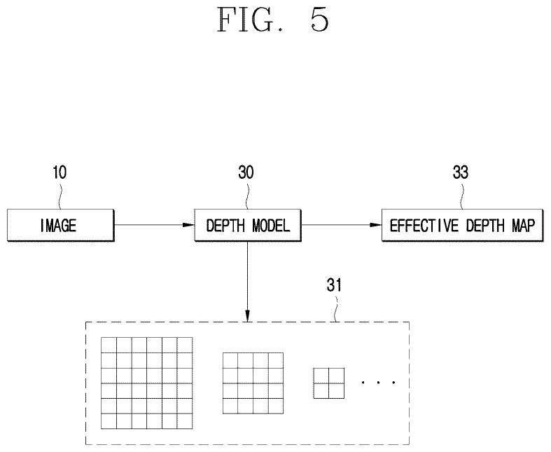

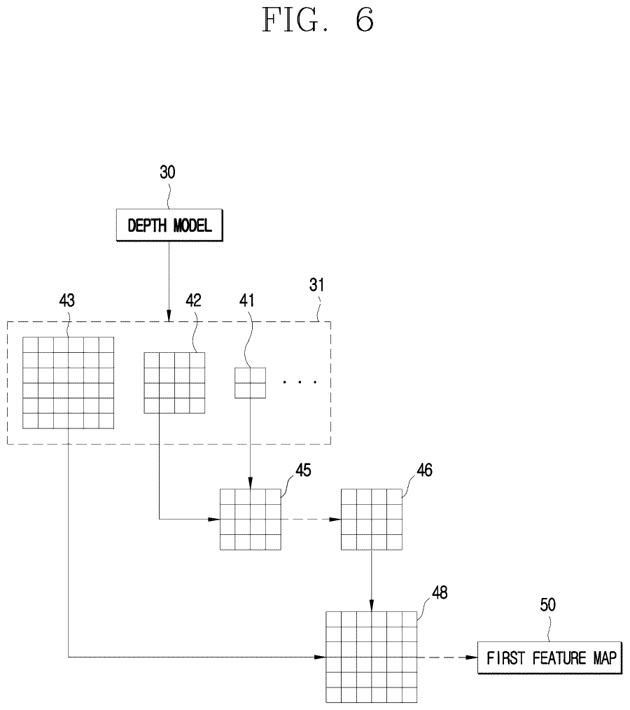

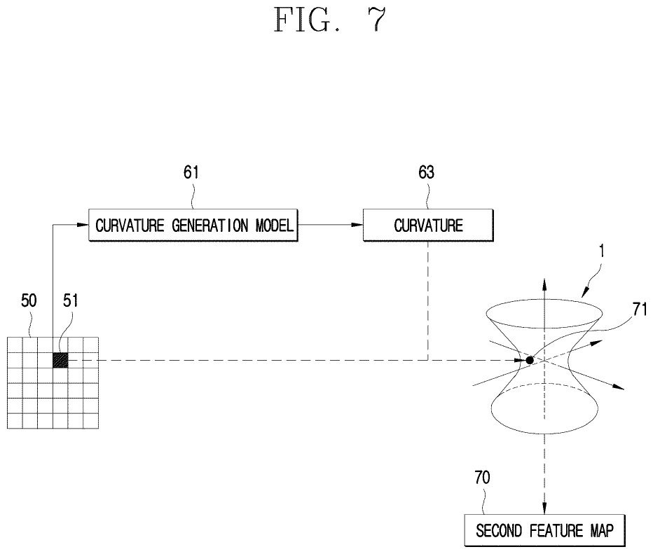

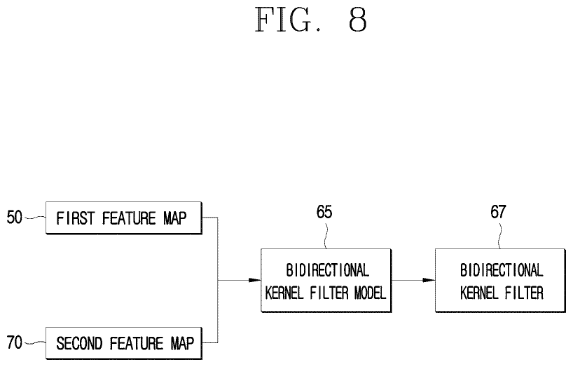

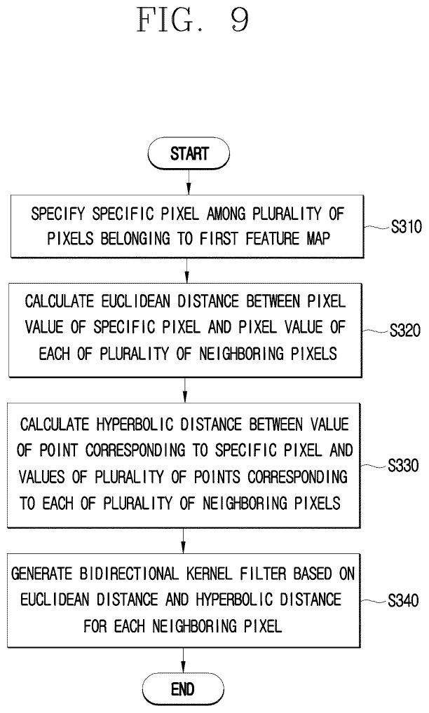

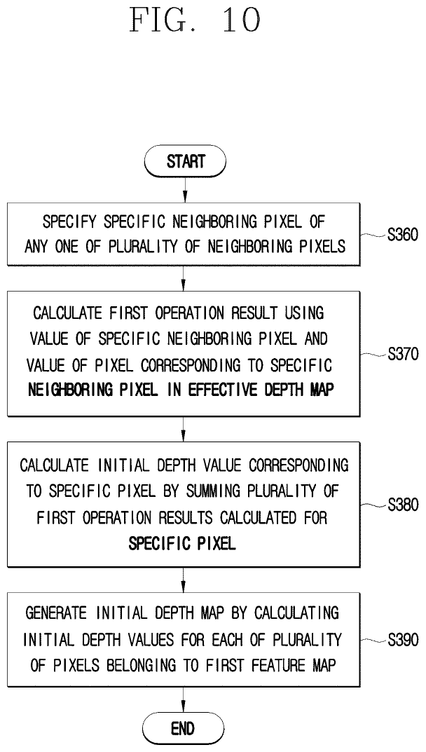

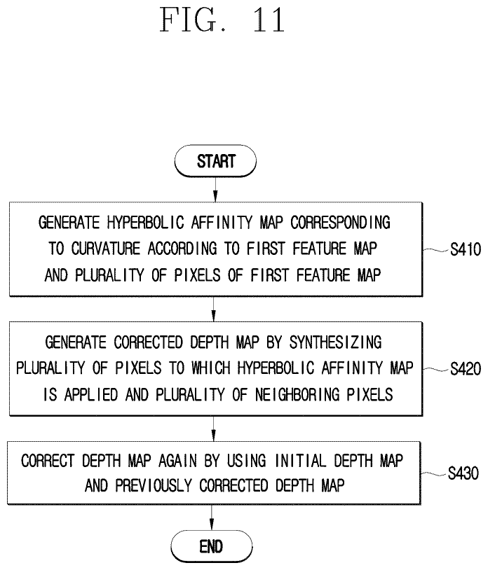

FIG. 4 illustrates a depth map estimation method according to the present invention. FIG. 5 illustrates an embodiment of generating the multiple feature maps. FIG. 6 illustrates an embodiment of generating the first feature map. FIG. 7 illustrates an embodiment of generating the second feature map. FIG. 8 illustrates an embodiment of generating the bidirectional kernel filter. FIG. 9 illustrates an embodiment of a method of generating a bidirectional kernel filter. FIG. 10 illustrates an embodiment of a method of generating an initial depth map. FIG. 11 illustrates an embodiment of a method of correcting an initial depth map.

### Feature Map Extraction

Referring to FIG. 4, the depth map estimation system 100 according to the present invention may acquire multiple feature maps corresponding to a given image using a pre-trained depth model (S100).

Specifically, the depth map estimation system 100 may input an image to the depth model in which different multiple scale factors are provided, and acquire multiple feature maps according to the multiple scale factors and the effective depth map according to the multiple feature maps.

Referring to FIG. 5, for example, when receiving a given image 10, the depth map estimation system 100 may input the image 10 to a depth model 30 in which basic training is performed based on large-scale training data, and bias tuning is performed based on a loss according to a training image and a ground-truth depth map to acquire multiple feature maps 31 and an effective depth map 33 corresponding to the corresponding image 10.

In this case, multiple scale factors may be provided in the depth model 10. Therefore, the depth map estimation system 100 may acquire the multiple feature maps 31 having different sizes by the multiple scale factors provided in the depth model.

For another example, the depth map estimation system 100 may receive an image in which any scene is captured and an effective depth map measured by a sensor provided in advance while capturing the corresponding image. In this case, the depth map estimation system 100 may acquire the multiple feature maps corresponding to the image through the depth model.

### Euclidean-Hyperbolic Feature Map

Referring back to FIG. 4, the depth map estimation system 100 according to the present invention may fuse multiple feature maps to generate a first feature map corresponding to an image in a Euclidean space, and map the first feature map to a hyperbolic space to generate a second feature map (S200).

Specifically, the depth map estimation system 100 may upsample any one of the multiple feature maps extracted based on the multiple scale factors provided in the depth model, and synthesize another feature map that is finer than the any one feature map and any one feature map previously upsampled to generate the first feature map.

Referring to FIG. 6, for example, the depth map estimation system 100 may upsample a relatively coarse feature map 41 among the multiple feature maps 31 and synthesize a fine feature map 42 that is finer than the coarse feature map 41 and an upsampled feature map 45.

To this end, the depth map estimation system 100 may perform a transposed convolution on the coarse feature map 41 to generate the upsampled feature map 45, and synthesize the upsampled feature map 45 and the fine feature map 42 through skip concatenation.

In addition, the depth map estimation system 100 may synthesize a feature map 46 in which the previously upsampled feature map 45 and the fine feature map 42 are synthesized, and another feature map 43 that is finer than the fine feature map 42. To this end, the depth map estimation system 100 may upsample the previously synthesized feature map 46, and again generate a synthesized feature map by skip-concatenating the upsampled feature map 48 to the finer feature map 43.

In this way, the depth map estimation system 100 may generate a first feature map 50 by repeatedly synthesizing the coarse feature map and the fine feature map as described above.

Furthermore, the depth map estimation system 100 may generate the curvature in the hyperbolic space corresponding to the first feature map using the pre-prepared curvature generation model, and map each of the plurality of pixel values belonging to the first feature map to the hyperbolic space based on the generated curvature to generate the second feature map.

Referring to FIG. 7, for example, the depth map estimation system 100 may input the first feature map 50 to the curvature generation model 61 to generate a curvature 63 corresponding to the first feature map 50, and specify a specific pixel 51 among a plurality of pixels belonging to the first feature map 50 and convert a pixel value of the previously specified specific pixel 51 into a value of a specific point 71 belonging to a hyperbolic space 1 based on the previously generated curvature 63.

Accordingly, the depth map estimation system 100 may convert a plurality of pixels belonging to the first feature map 50 into the hyperbolic space 1 based on the curvature 63 to generate a second feature map 70.

### Initial Depth Map Generation

Referring back to FIG. 4, the depth map estimation system 100 according to the present invention may estimate the bidirectional kernel filter using the first feature map and the second feature map, and generate the initial depth map using the bidirectional kernel filter and the effective depth map corresponding to the image (S300).

Specifically, the depth map estimation system 100 may calculate the Euclidean distance between the specific pixel and the neighboring pixel adjacent to the corresponding pixel in the first feature map, calculate the hyperbolic distance between the point corresponding to the specific pixel in the first feature map and the point corresponding to the neighboring pixel in the first feature map, in the second feature map, and generate the bidirectional kernel filter based on the previously calculated Euclidean distance and the hyperbolic distance.

Referring to FIG. 8, for example, the depth map estimation system 100 may input the first feature map 50 and the second feature map 70 into a bidirectional kernel filter model 65 composed of a multilayer perceptron layer, thereby acquiring bidirectional kernel filters 67 corresponding to the first feature map 50 and the second feature map 70.

Referring to FIG. 9, for another example, the depth map estimation system 100 may specify a specific pixel among a plurality of pixels belonging to a first feature map (S310), and confirm a plurality of neighboring pixels adjacent to the specific pixel to calculate a Euclidean distance between a pixel value of the specific pixel and pixel values of each of the plurality of neighboring pixels (S320).

In addition, the depth map estimation system 100 may calculate a hyperbolic distance between a value of a point corresponding to the specific pixel in the second feature map and values of a plurality of points corresponding to each of the plurality of neighboring pixels (S330).

Accordingly, for the previously specified specific pixel, the depth map estimation system 100 may generate the bidirectional kernel filter based on the Euclidean distance and the hyperbolic distance for each neighboring pixel (S340). In this case, the depth map estimation system 100 may calculate the bidirectional kernel filter according to a predetermined formula (e.g., multiplication) for the Euclidean distance and the hyperbolic distance, or acquire the bidirectional kernel filter by inputting the Euclidean distance and the hyperbolic distance to the bidirectional kernel filter model composed of the multilayer perceptron layer.

In this case, the depth map estimation system 100 may separately calculate the bidirectional kernel filter for each of the plurality of neighboring pixels based on the specific pixel, and may also calculate the bidirectional kernel filter for each of the plurality of pixels belonging to the first feature map.

Furthermore, the depth map estimation system 100 may generate the initial depth map using the bidirectional kernel filter corresponding to each of the plurality of neighboring pixels for the specific pixel in the first feature map, and the depth value of the pixel corresponding to each of the plurality of neighboring pixels in the effective depth map.

Referring to FIG. 10, for example, the depth map estimation system 100 may specify a specific neighboring pixel of any one of the plurality of neighboring pixels adjacent to a specific pixel in the first feature map (S360), and calculate a first operation result by using (or multiplying) the value of the corresponding specific neighboring pixel and the value of the pixel corresponding to the specific neighboring pixel in the effective depth map (S370).

In this case, the depth map estimation system 100 may calculate the first operation result for each of the plurality of neighboring pixels adjacent to the specific pixel, and calculate the initial depth value corresponding to the specific pixel by summing the plurality of first operation results calculated for the specific pixel (S380).

In this way, the depth map estimation system 100 may generate the initial depth map by calculating the initial depth values for each of the plurality of pixels belonging to the first feature map (S390).

### Initial Depth Map Correction

Referring back to FIG. 4, the depth map estimation system 100 according to the present invention may calculate the hyperbolic affinity map based on the curvature in the hyperbolic space estimated based on the first feature map, and generate the depth map corresponding to the image by correcting the initial depth map based on the hyperbolic affinity map (S400).

Specifically, referring to FIG. 11, the depth map estimation system 100 may generate the hyperbolic affinity map corresponding to the curvature according to the first feature map and the plurality of pixels of the first feature map by using the pre-prepared hyperbolic convolutional layer (S410).

For example, the depth map estimation system 100 may specify a specific pixel of any one of the plurality of pixels belonging to the first feature map, and generate a hyperbolic affinity value by considering a plurality of pixels corresponding to a predefined first kernel based on the previously specified specific pixel and a curvature corresponding to the first feature map.

In this case, the depth map estimation system 100 may calculate the hyperbolic affinity values for each of the plurality of pixels belonging to the first feature map to generate the hyperbolic affinity map.

Furthermore, the depth map estimation system 100 may generate the corrected depth map by applying the hyperbolic affinity map to the plurality of pixels corresponding to the corresponding kernel and each of the plurality of neighboring pixels adjacent to each of the plurality of pixels using the kernel having the predetermined size based on the specific pixel in the initial depth map, and synthesizing the plurality of pixels to which the hyperbolic affinity map is applied and the plurality of neighboring pixels (S420).

For example, the depth map estimation system 100 may correct the initial depth map by specifying a specific pixel of any one of the plurality of pixels belonging to the initial depth map and calculating a sum obtained by multiplying correction values for a plurality of pixels corresponding to a predefined second kernel based on the specified specific pixel by the reliability values corresponding to the plurality of pixels corresponding to the second kernel in the pre-prepared reliability map.

In this case, the depth map estimation system 100 may calculate the correction values for the plurality of pixels corresponding to the second kernel in the initial depth map using the hyperbolic affinity map and the initial depth map.

That is, the depth map estimation system 100 may specify a specific pixel of any one of the plurality of pixels corresponding to the second kernel in the initial depth map, confirm a corresponding pixel corresponding to the specific pixel in the hyperbolic affinity map, and acquire a second operation result through an element-wise product between a plurality of hyperbolic affinity values corresponding to the predefined second kernel and the specific pixel based on the corresponding pixel.

In addition, the depth map estimation system 100 may calculate an element-wise product between a plurality of pixel values corresponding to the second kernel based on each of the plurality of neighboring pixels adjacent to the specific pixel in the initial depth map and a plurality of pixel values corresponding to the second kernel based on each of the plurality of neighboring pixels adjacent to the corresponding pixel in the hyperbolic affinity map, and acquire a third operation result by summing the result values according to the element-wise product.

Accordingly, the depth map estimation system 100 may calculate a correction value for a specific pixel of any one of the plurality of pixels corresponding to the second kernel in the initial depth map by summing the second operation result and the third operation result.

In this case, the depth map estimation system 100 may calculate correction values for each of the plurality of pixels corresponding to the second kernel, correct a value of a specific pixel of the initial depth map using the plurality of calculated correction values and the reliability values corresponding to the plurality of correction values, and generate a corrected depth map by correcting the plurality of pixels belonging to the initial depth map according to the calculation process.

Furthermore, the depth map estimation system 100 may correct the depth map using the initial depth map and the previously corrected depth map again. To this end, the depth map estimation system 100 may generate the corrected depth map again by using the kernel having the predetermined size based on the specific pixel in the initial depth map to apply the hyperbolic affinity map to the plurality of pixels corresponding to the corresponding kernel in the initial depth map and each of the plurality of adjacent neighboring pixels in the previously corrected depth map for each of the plurality of pixels, and synthesizing the plurality of pixels in the initial depth map to which the hyperbolic affinity map is applied and the plurality of neighboring pixels in the previously corrected depth map (S430).

By the configurations described above, according to the depth map estimation system 100 according to the present invention, by generating the feature maps in the Euclidean space and the feature maps in the hyperbolic space using the multiple feature maps acquired from the images based on the multiple scale factors, and generating the depth maps by considering each feature map, it is possible to generate the depth maps with stable quality from the images acquired through various types of monocular cameras or depth sensors.

In addition, according to the depth map estimation system 100 according to the present invention, by estimating the initial depth map and correcting the initial depth map using the feature map in the Euclidean space and the pixel-wise affinity map based on the curvature in the hyperbolic space, it is possible to generate the more accurate and dense depth map.

Furthermore, the depth map estimation system 100 according to the present invention can be implemented through a computing device described below and can perform the data processing related to the depth map estimation method described above.

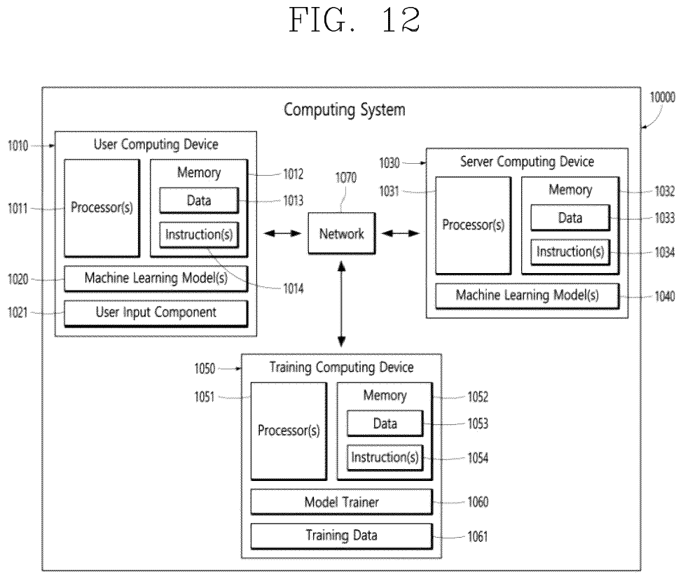

Meanwhile, FIG. 12 illustrates an example block diagram of a computing system in which the present invention may be implemented.

Referring to FIG. 12, a computing system (10000) for performing a depth map estimation method using a universal framework according to an embodiment of the present invention may include at least one computing device. In this case, the at least one computing device may be a single-processor or multi-processor computing apparatus.

The components of the at least one computing device of the present invention may include one or more processors, memory, other hardware, and various system components connected (e.g., communicatively, physically, or electrically connected) via a system bus (not shown) that enables data to be transmitted and received among them. The components of the at least one computing device are not limited thereto and may vary widely.

Meanwhile, the at least one computing device included in the computing system (10000) that performs a depth map estimation method using a universal framework may be communicatively connected via a network (1070). For example, the at least one computing device included in the computing system (10000) may be clustered or may be part of a local area network (LAN). Additionally, the at least one computing device may be part of a wide area network (WAN) or connected via at least one of a client-server network or a peer-to-peer network in a cloud environment.

Meanwhile, when the at least one computing device is used in at least one environment among a network environment and a cloud computing environment, the at least one computing device may be connected to at least one of a public network and a private network through a network interface or adapter. In one embodiment, other communication connection devices, such as a modem, may be used to establish communication over the network. The modem may be at least one of an internal modem and an external modem, and may be connected to the system bus through a network interface or a specific mechanism. A wireless network component comprising an interface and an antenna may be coupled to the network through devices such as access points or peer computers. In the present invention, the method by which the at least one computing device is communicatively connected via the network (1070) is not limited thereto and may be implemented by means other than the examples described above.

Furthermore, other computer-type devices and/or systems not illustrated in FIG. 12 may technically interact with the at least one computing device or other systems through one or more connections to the network (1070) via a network interface. Here, the network interface may include network interface equipment such as a physical Network Interface Controller (NIC) or a Virtual Interface (VIF).

The computing system (10000) for performing a depth map estimation method using a universal framework according to the present invention may include at least one of a user computing device (1010), a training computing device (1050), and a server computing device (1030).

The user computing device (1010) according to the present invention may be understood as a computing device including at least one processor (1011) and memory (1012) for performing the depth map estimation method using a universal framework. For example, the user computing device (1010) may include at least one computing device selected from among a smart phone, smart TV, laptop computer, desktop computer, digital broadcasting terminal, personal digital assistant (PDA), portable multimedia player (PMP), navigation device, slate PC, tablet PC, ultrabook, and wearable device (e.g., smartwatch, smart glass, and head-mounted display (HMD)).

The at least one processor (1011) constituting the user computing device (1010) may include one or more general-purpose processors and/or one or more special-purpose processors. For example, the at least one processor (1011) of the user computing device (1010) may include at least one or a combination of electrically connected processors selected from the group consisting of: a Central Processing Unit (CPU), a Graphics Processing Unit (GPU), a Tensor Processing Unit (TPU), a Neural Processing Unit (NPU), an Arithmetic Logic Unit (ALU), a Floating Point Unit (FPU), an Application-Specific Integrated Circuit (ASIC), a digital signal processing device (DSPD), a programmable logic device (PLD), a Field Programmable Gate Array (FPGA), a controller, a microcontroller, a microprocessor, and other electrical units for performing specific functions.

Furthermore, the at least one processor (1011) may be configured to execute computer-readable instructions stored in the memory (1012) and/or other commands described in the present specification.

The memory (1012) constituting the user computing device (1010) according to the present invention may include volatile memory, non-volatile memory, fixed media, removable media, magnetic media, optical media, semiconductor media, and/or other types of physically durable storage media.

For example, the memory (1012) may include one or more non-transitory/transitory computer-readable storage media, or combinations thereof, such as Random Access Memory (RAM), Read Only Memory (ROM), Hard Disk Drive (HDD), Solid State Disk (SSD), Silicon Disk Drive (SDD), Electrically Erasable Programmable Read-Only Memory (EEPROM), Erasable Programmable Read-Only Memory (EPROM), flash memory devices, and magnetic disks. It may also include web storage of a server that performs the memory storage function over the Internet.

The memory (1012) may store data and instructions necessary for the at least one processor (1011) to perform operations of an application for depth map estimation using a universal framework.

The user computing device (1010) may include one or more user input components (1021) configured to detect user input. For example, the user input component (1021) may also be referred to as a user interface module. The user input component (1021) may include devices such as a touchscreen, computer mouse, keyboard, keypad, touchpad, trackball, joystick, voice recognition module, or other similar devices. However, the present invention does not limit the types of the user input component (1021).

In this context, the user input component (1021) in the present invention is not necessarily limited to a hardware means but may be understood as a channel through which input is received from a user.

Meanwhile, the “user” in the present invention may also refer to an automated agent, script, playback software, or the like that operates on behalf of one or more human users.

A user may interact with the computing system (10000), which includes at least one computing device, through the user input component (1021) using inputted text, touch, voice, motion, computer vision, gesture, and/or other forms of input/output. For example, the user input component (1021) may include one or more user interface (UI) modalities such as a Command Line Interface (CLI), Graphical User Interface (GUI), Natural User Interface (NUI), voice command interface, and/or other UI representations.

One or more Application Programming Interface (API) calls may be made between the user input component (1021) and the user computing device (1010), based on user input received through a user interface and/or from a network.

Herein, the phrase “based on” may be interpreted to include instances where a particular configuration is used as a foundation, modified from, derived from, influenced by, dependent on, or otherwise originating from such configuration.

In some embodiments, the API call may be configured for a specific API and may be interpreted as, or converted into, an API call configured for a different API. In this context, the API may refer to a defined interface or connection between computers or between computer programs.

In one embodiment, the user computing device (1010) may store one or more machine learning models (1020). For example, the user computing device (1010) may include various machine learning models, such as multiple neural networks (e.g., deep neural networks) for generating a depth map corresponding to an input image, or other types of machine learning models including nonlinear models and/or linear models or may be configured as a combination thereof.

According to an embodiment of the present invention, the user computing device (1010) may perform a depth map estimation method using a universal framework by using a local and/or external machine learning model (1020). Alternatively, the user computing device (1010) may perform the depth map estimation method using a universal framework by using a machine learning model (1040) provided by a server.

According to another embodiment of the present invention, a server computing device (1030) communicating with the user computing device (1010) may provide a depth map corresponding to an image to the user computing device (1010) via an application and/or a web interface, in response to a user request received through the user computing device (1010).

According to yet another embodiment of the present invention, at least a portion of the user computing device (1010) and the server computing device (1030) may be cooperatively operated to perform a depth map estimation method using a universal framework, thereby providing a depth map corresponding to an image to the user.

According to various embodiments of the present invention, the user computing device (1010) and/or the server computing device (1030) may train the machine learning models (1020, 1040) used in the depth map estimation method using a universal framework through interaction with a training computing device (1050) that is communicatively connected via the network (1070).

In this case, the training computing device (1050) may be a computing system separate from the server computing device (1030). Alternatively, in some embodiments, the training computing device (1050) may be a part of the server computing device (1030) or a part of the user computing device (1010).

Meanwhile, the server computing device (1030) may include at least one processor (1031) and memory (1032). Here, the processor (1031) may include at least one or a combination of electrically connected processors selected from among: a Central Processing Unit (CPU), Graphics Processing Unit (GPU), Tensor Processing Unit (TPU), Neural Processing Unit (NPU), Application-Specific Integrated Circuit (ASIC), Arithmetic Logic Unit (ALU), Floating Point Unit (FPU), digital signal processing devices (DSPDs), programmable logic devices (PLDs), Field Programmable Gate Arrays (FPGAs), controllers, microcontrollers, microprocessors, and/or other electrical units for performing specific functions. For example, the at least one processor (1031) may include circuits and transistors configured to execute instructions from the memory (1032).

The memory (1032) constituting the server computing device (1030) according to the present invention may include volatile memory, non-volatile memory, fixed media, removable media, magnetic media, optical media, semiconductor media, and/or other types of physically durable storage media.

For example, the memory (1032) may include one or more transitory/non-transitory computer-readable storage media, or combinations thereof, such as Random Access Memory (RAM), Read Only Memory (ROM), Hard Disk Drive (HDD), Solid State Disk (SSD), Silicon Disk Drive (SDD), Electrically Erasable Programmable Read-Only Memory (EEPROM), Erasable Programmable Read-Only Memory (EPROM), flash memory devices, and magnetic disks. It may also include web storage of a server that performs memory storage functions over the Internet.

Additionally, the server computing device (1030) may further include a data store. For example, the data store may be configured as at least one of a relational database, a NoSQL database, a data warehouse, and a local file system.

The memory (1032) constituting the server computing device (1030) according to the present invention may store data and instructions necessary for the at least one processor (1031) to perform operations of an application for depth map estimation using a universal framework.

In one embodiment, the server computing device (1030) may be configured as a single device or as a plurality of computing devices, which may be configured to operate according to a sequential or parallel computing architecture. Additionally, the system may be implemented as a distributed processing system comprising multiple devices connected over a network.

Meanwhile, the training computing device (1050) may include at least one processor (1051) and memory (1052). A model trainer (1060), as a logical component that performs training of at least one machine learning model (1020, 1040), may be implemented in the form of hardware, firmware, or software.

For example, the model trainer (1060) may load training data (1061) stored in a storage device into the memory (1052), and then be executed by the processor (1051). The model trainer (1060) may be configured to perform one or more operations—such as model training, model reconstruction, model validation, and model testing—on at least one machine learning model.

The machine learning model according to the present invention may include at least one of the following: a statistical model, an algorithm, a neural network (NN), a convolutional neural network (CNN), a generative neural network (GNN), a Word2Vec model, a Bag of Words model, a Term Frequency-Inverse Document Frequency (TF-IDF) model, a Generative Pre-trained Transformer (GPT) model (or other autoregressive models), a Proximal Policy Optimization (PPO) model, a nearest neighbor model (e.g., k-nearest neighbor model), a linear regression model, a k-means clustering model, a Q-learning model, a Temporal Difference (TD) model, a Deep Adversarial Network model, and any other type of model described in the present specification.

Specifically, the model trainer (1060) may perform operations for training a machine learning model, and the operations may include at least one of adding, removing, and modifying model parameters. In this case, the training of the machine learning model may be at least one of supervised learning, semi-supervised learning, and unsupervised learning.

In one embodiment, training of the machine learning model may include a step of repeatedly inputting the training data (1061) based on epochs, and iteratively performing the machine learning model training process configured in this manner. Here, an epoch may refer to a unit representing one complete forward and backward pass of the entire training data (1061) set.

In some implementations, different learning methods (e.g., supervised learning, semi-supervised learning, and unsupervised learning) may be applied at different epochs.

The training data (1061) of the present invention may include input data and/or data previously output from at least one machine learning model (e.g., recursive learning feedback).

The parameters of the at least one machine learning model may include at least one of a seed value, model nodes, model layers, algorithms, functions, connections between different machine learning models, connections between parameters, constraints of the machine learning model, and other digital components that influence the output of the machine learning model.

In this case, a model connection between different machine learning models may include or represent relationships between model parameters and/or between models, which may be dependent, interdependent, hierarchical, and/or static or dynamic.

The combination and configuration of the model parameters described herein may be too complex to be maintained or utilized by human cognitive capabilities.

The present invention does not limit the parameters of machine learning models to those described in the embodiments, and a single machine learning model may include a plurality of model parameters.

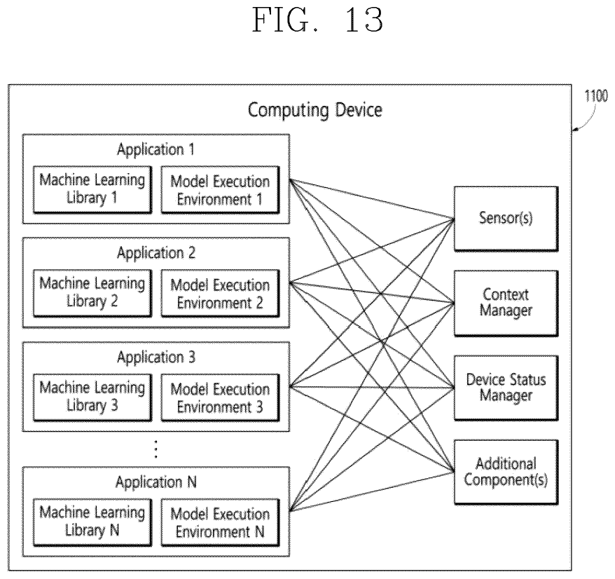

Meanwhile, FIG. 13 illustrates an example block diagram of a computing device (1100), which may be included in the user computing device (1010), the server computing device (1030), or the training computing device (1050), as one embodiment of the computing system (10000) in which the present invention may be implemented.

As shown in FIG. 13, the computing device (1100) may include at least one application (e.g., Application 1 to Application N), and each of the at least one application may include a machine learning library and a model execution environment for performing a depth map estimation method using a universal framework, using machine learning.

Each of the at least one application included in the computing device (1100) may communicate via an Application Programming Interface (API) with one or more components within the computing device (1100), such as sensors, a context manager, a device state manager, or additional components.

In one embodiment, the at least one application may interface with device components by, for example, receiving sensor data or state data via a public or dedicated API, or transmitting prediction results to an output device.

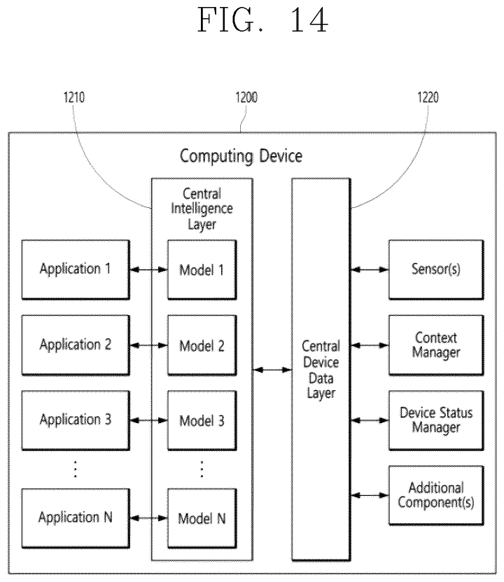

Meanwhile, FIG. 14 illustrates an example block diagram of a computing device (1200), which is one component of the computing system (10000) performing the depth map estimation method using a universal framework according to an embodiment of the present invention, from another perspective.

The computing device (1200) according to the present invention may include at least one application (e.g., Application 1 to Application N), and each of the at least one application may communicate with a central intelligence layer (1210). Each application may interact with a shared model within the central intelligence layer (1210) via an API (e.g., a common API).

The central intelligence layer (1210) may include one or more machine learning models and may either share them among multiple applications or provide them independently to each application. In one embodiment, the central intelligence layer (1210) may be integrated as part of the operating system or implemented as a separate logical layer.

Additionally, the central intelligence layer (1210) may communicate with a central device data layer (1220). The central device data layer (1220) may integratively store predefined images and the like stored within the computing device (1200) and provide them as input data required for depth map estimation using a universal framework. Each device component (e.g., sensors, state managers, etc.) may communicate with the central device data layer (1220) via a private API or the like.

The technology described in the present specification may be implemented using a single computing device or multiple computing devices. A machine learning model for performing a depth map estimation method using a universal framework may be executed sequentially or in parallel on a single component or across multiple distributed components. The data store, machine learning models, and applications may be distributed and operated locally or over a network, and these components may be flexibly applied to various system architectures.

In the above description, the depth map estimation system 100 of the present invention has been described as being implemented as a computing system, but the present invention is not limited thereto. For example, the functions of the neural network and/or the computing device may be distributed among a plurality of computing clusters.

In addition, the present invention described above may be implemented as a program that is executed by one or more processes in the electronic device and stored in the computer-readable recording medium.

Therefore, the present invention can be implemented as a computer-readable code or instruction in the medium in which the program is recorded. That is, various control methods according to the present invention may be provided in the form of an integrated or individual program.

Meanwhile, the computer-readable medium includes all types of recording devices in which data that can be read by the computer system is stored. An example of the computer-readable medium may include a hard disk drive (HDD), a solid state disk (SSD), a silicon disk drive (SDD), a ROM, a RAM, a CD-ROM, a magnetic tape, a floppy disk, an optical data storage device, etc.

Furthermore, the computer-readable medium may be a server or cloud storage that includes storage and that the electronic device may access through communication. In this case, the computer may download the program according to the present invention from the server or cloud storage through wired or wireless communication.

Furthermore, in the present invention, the computer described above is an electronic device equipped with a processor, that is, a central processing unit (CPU), and there is no particular limitation on its type.

Meanwhile, the above-described detailed description is to be interpreted as being illustrative rather than being restrictive in all aspects. The scope of the present invention is to be determined by reasonable interpretation of the claims, and all modifications within an equivalent range of the present invention fall in the scope of the present invention.

What is claimed is:

1. A depth map estimation method processed by a computing device, comprising:
acquiring multiple feature maps corresponding to a given image using a pre-trained depth model;
generating a first feature map corresponding to the image in a Euclidean space by fusing the multiple feature maps, and generating a second feature map by mapping the first feature map to a hyperbolic space;
estimating a bidirectional kernel filter using the first feature map and the second feature map, and generating an initial depth map using the bidirectional kernel filter and an effective depth map corresponding to the image; and
calculating a hyperbolic affinity map based on a curvature in the hyperbolic space estimated based on the first feature map, and generating a depth map corresponding to the image by correcting the initial depth map based on the hyperbolic affinity map.

2. The depth map estimation method of claim 1, wherein, in the acquiring of the multiple feature maps, the image is input to the depth model provided with different multiple scale factors to acquire the multiple feature maps according to the multiple scale factors and the effective depth map according to the multiple feature maps.

3. The depth map estimation method of claim 1, wherein the generating of the first feature map includes:
upsampling any one of the multiple feature maps extracted based on the multiple scale factors provided in the depth model; and
generating the first feature map by synthesizing another feature map that is finer than one of the multiple feature maps and the upsampled one feature map.

4. The depth map estimation method of claim 1, wherein the generating of the second feature map includes:
generating a curvature in a hyperbolic space corresponding to the first feature map using a pre-prepared curvature generation model; and
generate the second feature map by mapping each of a plurality of pixel values belonging to the first feature map to the hyperbolic space based on the generated curvature.

5. The depth map estimation method of claim 1, wherein the generating of the initial depth map includes:
calculating a Euclidean distance between a specific pixel and a neighboring pixel adjacent to the specific pixel, in the first feature map;
calculating a hyperbolic distance between a point corresponding to the specific pixel in the first feature map and a point corresponding to the neighboring pixel in the first feature map, in the second feature map; and
generating the bidirectional kernel filter based on the calculated Euclidean distance and the hyperbolic distance.

6. The depth map estimation method of claim 1, wherein, in the generating of the initial depth map, the initial depth map is generated by using the bidirectional kernel filter corresponding to each of a plurality of neighboring pixels for a specific pixel in the first feature map, and a depth value of a pixel corresponding to each of the plurality of neighboring pixels in the effective depth map.

7. The depth map estimation method of claim 1, wherein the generating of the depth map corresponding to the image includes generating a curvature according to the first feature map and the hyperbolic affinity map corresponding to a plurality of pixels of the first feature map by using a pre-prepared hyperbolic convolutional layer.

8. The depth map estimation method of claim 1, wherein the generating of the depth map corresponding to the image includes:
applying a hyperbolic affinity map to a plurality of pixels corresponding to a kernel having a predetermined size, by using the kernel based on a specific pixel in the initial depth map, and to each of a plurality of neighboring pixels adjacent to each of the plurality of pixels; and
generating a corrected depth map by synthesizing the plurality of pixels to which the hyperbolic affinity map is applied and the plurality of neighboring pixels.

9. A depth map estimation system, comprising:
a storage unit in which a pre-trained depth model is prepared; and
a control unit acquiring multiple feature maps corresponding to a given image using the depth model, and generating a depth map corresponding to the image using the multiple feature maps,
wherein the control unit generates a first feature map corresponding to the image in a Euclidean space by fusing the multiple feature maps, generates a second feature map by mapping the first feature map to a hyperbolic space, estimates a bidirectional kernel filter using the first feature map and the second feature map, generates an initial depth map using the bidirectional kernel filter and an effective depth map corresponding to the image, calculates a hyperbolic affinity map based on a curvature in the hyperbolic space estimated based on the first feature map, and generates a depth map corresponding to the image by correcting the initial depth map based on the hyperbolic affinity map.

10. The depth map estimation system of claim 9,
wherein, in acquiring the multiple feature maps, the control unit is configured to input the image to the depth model provided with different multiple scale factors to acquire the multiple feature maps according to the multiple scale factors and the effective depth map according to the multiple feature maps.

11. The depth map estimation system of claim 9,
wherein the control unit is configured to generate the first feature map by:
upsampling any one of the multiple feature maps extracted based on the multiple scale factors provided in the depth model; and
synthesizing another feature map that is finer than one of the multiple feature maps with the upsampled one feature map.

12. The depth map estimation system of claim 9,
wherein the control unit is configured to generate the second feature map by:
generating a curvature in a hyperbolic space corresponding to the first feature map using a pre-prepared curvature generation model; and
mapping each of a plurality of pixel values belonging to the first feature map to the hyperbolic space based on the generated curvature.

13. The depth map estimation system of claim 9,
wherein the control unit is configured to generate the initial depth map by:
calculating a Euclidean distance between a specific pixel and a neighboring pixel adjacent to the specific pixel in the first feature map;
calculating a hyperbolic distance between a point corresponding to the specific pixel in the first feature map and a point corresponding to the neighboring pixel in the first feature map in the second feature map; and
generating the bidirectional kernel filter based on the calculated Euclidean distance and the hyperbolic distance.

14. The depth map estimation system of claim 9,
wherein, in generating the initial depth map, the control unit is configured to generate the initial depth map by using the bidirectional kernel filter corresponding to each of a plurality of neighboring pixels for a specific pixel in the first feature map, and a depth value of a pixel corresponding to each of the plurality of neighboring pixels in the effective depth map.

15. A program stored in a non-transitory computer-readable storage medium, executed by one or more processes in an electronic device, wherein the program includes instructions to perform:
acquiring multiple feature maps corresponding to a given image using a pre-trained depth model;
generating a first feature map corresponding to the image in a Euclidean space by fusing the multiple feature maps, and generating a second feature map by mapping the first feature map to a hyperbolic space;
estimating a bidirectional kernel filter using the first feature map and the second feature map, and generating an initial depth map using the bidirectional kernel filter and an effective depth map corresponding to the image; and
calculating a hyperbolic affinity map based on a curvature in the hyperbolic space estimated based on the first feature map, and generating a depth map corresponding to the image by correcting the initial depth map based on the hyperbolic affinity map.

16. The non-transitory computer-readable storage medium of claim 15,
wherein the instructions, when executed by one or more processors, cause the one or more processors, in acquiring the multiple feature maps, to input the image to the pre-trained depth model provided with different multiple scale factors to acquire the multiple feature maps according to the multiple scale factors and the effective depth map according to the multiple feature maps.

17. The non-transitory computer-readable storage medium of claim 15,
wherein the instructions, when executed by one or more processors, cause the one or more processors to generate the first feature map by:
upsampling any one of the multiple feature maps extracted based on the multiple scale factors provided in the depth model; and
synthesizing another feature map that is finer than one of the multiple feature maps with the upsampled one feature map.

18. The non-transitory computer-readable storage medium of claim 15,
wherein the instructions, when executed by one or more processors, cause the one or more processors to generate the second feature map by:
generating a curvature in a hyperbolic space corresponding to the first feature map using a pre-prepared curvature generation model; and
mapping each of a plurality of pixel values belonging to the first feature map to the hyperbolic space based on the generated curvature.

19. The non-transitory computer-readable storage medium of claim 15,
wherein the instructions, when executed by one or more processors, cause the one or more processors to generate the initial depth map by:
calculating a Euclidean distance between a specific pixel and a neighboring pixel adjacent to the specific pixel in the first feature map;
calculating a hyperbolic distance between a point corresponding to the specific pixel in the first feature map and a point corresponding to the neighboring pixel in the first feature map in the second feature map; and
generating the bidirectional kernel filter based on the calculated Euclidean distance and the hyperbolic distance.

20. The non-transitory computer-readable storage medium of claim 15,
wherein the instructions, when executed by one or more processors, cause the one or more processors, in generating the initial depth map, to generate the initial depth map by using the bidirectional kernel filter corresponding to each of a plurality of neighboring pixels for a specific pixel in the first feature map, and a depth value of a pixel corresponding to each of the plurality of neighboring pixels in the effective depth map.
